(19) United States
(12) Patent Application Publication
(10) Pub. No.: US 2026/0018979 A1
(43) Pub. Date: Jan. 15, 2026

(54) LINEAR MOTOR ACTUATOR RAIL REMOVAL DEVICE

(71) Applicant: Toyota Motor Engineering & Manufacturing North America, Inc., Plano, TX (US)

(72) Inventors: Timothy M. Gardiner, Kitchener (CA); Kyle S. Mackie, Maryhill (CA); Jonathan P. Byles, Fordwich (CA)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/772,469

(22) Filed: Jul. 15, 2024

(51) Int. Cl. H02K 15/00; H02K 41/02

(52) U.S. Cl. CPC H02K 15/50; H02K 41/02

(57) ABSTRACT

The device described herein facilitates the removal of a guide rail of a linear motor actuator. In one embodiment, the rail removal device includes a first plate having a first mating surface that aligns with a first lateral side of a guide rail of a linear motor actuator. The rail removal device also includes a second plate having a second mating surface that aligns with a second lateral side of the guide rail. The rail removal device includes a joining structure connecting the first plate and the second plate. When closed, the joining structure juxtaposes the mating surfaces to define a channel that clamps against the guide rail. The rail removal device also includes a handle affixed to a plate.

### TECHNICAL FIELD

The subject matter described herein relates, in general, to linear motor actuator guide rails and, more particularly, to a device to safely remove the guide rails from the linear motor actuator.

### BACKGROUND

An electric motor is a device that converts electrical energy into mechanical energy. Many electric motors generate mechanical energy via the interaction between the motor's magnetic field and an applied electric current. In a direct current (DC) electric motor, a rotor (i.e., core of metal material) and attached axle spin between fixed magnetic poles of a stator responsive to applying an electric current to the metal material, generating a temporary electromagnetic field. In an alternating current (AC) electric motor, a ring of electromagnets generates a rotating magnetic field. This rotating magnetic field induces electric currents in the rotor, which causes the rotor and a joined axle to spin.

A linear motor is an electric motor with planar stator and rotor components rather than circular stator and rotor components. For example, a base of the linear motor may include a set of magnetic plates (similar to a stator of a rotary electric motor) aligned in a linear direction. A moving platform (similar to a rotor of the rotary electric motor) may include coils that receive a current, which changes the polarity of the coils. An AC power supply and servo controller change the current phase of the coils of the rotor/moving platform to alter the polarity of the coil/rotor. The attractive and repulsive forces between the coils (with their changing polarity) and the magnetic plates generate a linear form. Responsive to this force, the moving platform slides along rails disposed on either side of the stationary magnetic plates.

Linear motors may be used in many applications, including automated industrial fabrication, machine tools, material handling, automotive, amusement rides, and even train propulsion. Linear motors may be particularly useful when highly precise positioning is desired. For example, linear motors may be used as cartesian coordinate robots, for semiconductor manufacturing and assembly, and in automotive assembly to move various vehicular components within a manufacturing facility.

### SUMMARY

In one embodiment, example rail removal devices facilitate the safe removal of guide rails from a linear motor actuator. The rail removal device includes 1) a first plate having a first mating surface that aligns with a first lateral side of a guide rail of a linear motor actuator and 2) a second plate having a second mating surface that aligns with a second lateral side of the guide rail. The rail removal device also includes a joining structure connecting the first plate and the second plate. When closed, the joining structure juxtaposes the mating surfaces to define a channel that clamps against the guide rail. The rail removal device also includes a handle affixed to a plate.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIGS. 1A and 1B are views of a linear motor actuator including a guide rail that is removable using the rail removal device disclosed herein.

FIG. 2 is an isometric view of the rail removal device on the guide rail of the linear motor actuator.

FIG. 3 is a cross-sectional view of the rail removal device on the guide rail of the linear motor actuator.

FIG. 4 is an exploded view of the rail removal device.

### DETAILED DESCRIPTION

A device is disclosed that improves the maintenance of a linear motor actuator, specifically by ensuring the safe removal of guide rails of the linear motor actuator along which a movable platform/rotor slides. As previously described, a linear motor is an electric motor with planar stator and rotor components, rather than circular stator and rotor components. An AC power supply and servo controller change the current phase of the coils of a movable platform. The change of the current phase changes the polarity of the coils. The attractive and repulsive forces between the coils (with their changing polarity) and stationary magnetic plates beneath the movable platform translate the movable platform along the guide rails.

Over time, components of the linear motor actuator may wear down and negatively impact the operation of the linear motor actuator. For example, the movable platform may include linear bearings that slide within the grooves of the guide rails. The bearings and guide rail grooves facilitate the magnetically triggered movement of the movable platform relative to the stationary magnetic plates. However, over time, the bearings and guide rails may wear down. As the bearings and guide rails wear down, the precision and smoothness of the movement of the movable platform may be negatively impacted. As such, operations that rely on the precision afforded by a linear motor actuator may suffer due to the loss of precision that results from bearing/rail wear. Accordingly, the guide rails and bearings may be replaced to again provide highly precise and smooth linear actuation.

However, replacing the guide rails may expose a technician to bodily harm and/or may damage the linear motor actuator. For example, the magnetic force of the magnetic plates can be very strong. During removal of the guide rail, this magnetic force may powerfully draw the guide rails to the magnetic plates, given the proximity of the guide rails to the magnetic plates. The magnetic force is strong enough that one technician may have difficulty removing the magnetically drawn guide rail from the magnetic plates. Moreover, during removal, a technician's fingers may be pinched between the guide rail they are holding and the magnetic plates that are immediately adjacent to the guide rails and that magnetically attract the guide rails. Additionally, the strong magnetic force may cause damage to the magnetic plates, the guide rails that are to be replaced, and other nearby objects, whether the nearby objects are components of the linear motor actuator or other fabrication/assembly equipment.

Accordingly, the present rail removal device promotes operator safety and equipment preservation. Specifically, the present specification describes a rail installation and removal clamp for a linear motor actuator. The rail removal device includes a 2-plate clamp made of aluminum, a nonferrous alloy that is not attracted to the magnetic plates. The two plates join together to form a channel with a cross-sectional shape/size that matches the cross-sectional shape/size of the guide rail. The rail removal device has a width that approximates or spans the width of the magnetic plates underneath. Accordingly, the plates form a physical barrier preventing the guide rails from flipping, twisting, or being drawn to and against the magnetic plates. The rail removal device also includes a handle to 1) provide a solid grasping and lifting surface and 2) position the operator's fingers away from the guide rail and magnetic plates. The handle is attached to the plates to withstand any force used to remove a guide rail that may become magnetically attached to the magnetic plates.

In this way, the disclosed rail removal device prevents magnetic adhesion of the guide rails to the magnetic plates via a plate-blocking removal device formed of a non-ferrous material that is not magnetically attracted to the magnetic plates. The rail removal device securely grabs the guide rail via a rail-matching channel. Operator safety is promoted by removing the operator's hands from a region between the guide rails and the magnetic plates where a strong magnetic attraction is present.

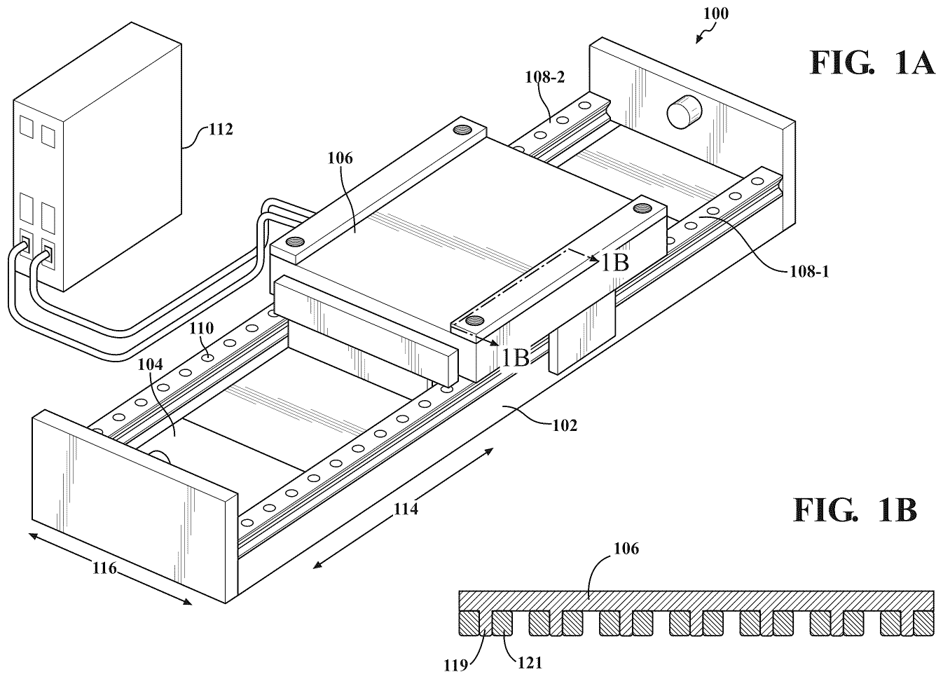

Turning now to the figures, FIGS. 1A and 1B depict views of a linear motor actuator 100 including guide rails 108-1 and 108-2 that are removable using the rail removal device disclosed herein. Specifically, FIG. 1A depicts an isometric view of the linear motor actuator and FIG. 1B is a cross-sectional view taken along the line 1B in FIG. 1A, depicts a portion of the movable platform 106. It will be appreciated that for simplicity and clarity of illustration, where appropriate, reference numerals have been repeated among the different figures to indicate corresponding or analogous elements. The inclusion of the designator -* indicates a particular instance of an element, while the lack of such a designator references a general instance of an element. In addition, the discussion outlines numerous specific details to provide a thorough understanding of the embodiments described herein. Those of skill in the art, however, will understand that the embodiments described herein may be practiced using various combinations of these elements.

As previously described, a linear motor actuator 100 includes an electric motor with planar stator and rotor components, rather than circular stator and rotor components. Specifically, the linear motor actuator 100 includes a base 102, which may be formed from a metallic material such as aluminum. The base 102 supports other components of the linear motor actuator 100 and is a mounting surface for the linear motor actuator 100. For example, the base 102 may be bolted to a fixed surface such as a workbench, manufacturing table, or manufacturing facility floor surface. A series of magnetic plates 104 are rigidly mounted to the base 102. For example, each magnetic plate 104 may sit within a channel of the base 102 or may be bolted or otherwise affixed to the base 102. For simplicity, a single instance of a magnetic plate 104 is indicated with a reference number. However, multiple magnetic plates 104 may be arranged end-to-end along a length direction 114 of the base 102. Each magnetic plate 104 has two poles designated “south” and “north.”

In an example, the magnetic plates 104 are arranged so that alternating poles align. For example, a second magnetic plate may be arranged next to a first magnetic plate, and a third magnetic plate may be arranged next to the second magnetic plate such that the second magnetic plate is between the first and third magnetic plates. In this arrangement, the second magnetic plate may be arranged such that the north pole of the second magnetic plate is adjacent to the south pole of the first magnetic plate. Moreover, the third magnetic plate may be arranged such that the north pole of the third magnetic plate is adjacent to the south pole of the second magnetic plate. Put another way, each magnetic plate 104 may be arranged on the base 102 in the same polar orientation such that the poles of a particular magnetic plate are adjacent opposite poles of the adjacent magnetic plates.

In another arrangement, the magnetic plates 104 may be arranged such that opposing poles of adjacent plates are facing the movable platform 106. For example, a first magnetic plate may have its north pole facing the movable platform 106 while the south pole of the first magnetic plate faces the base 102. In this example, a second magnetic plate may have its south pole facing the movable platform 106 while the north pole of the second magnetic plate faces the base 102. Still in this example, a north pole of a third magnetic plate (that is adjacent to the second magnetic plate) may have its north pole facing the movable platform 106 while the south pole of the third magnetic plate faces the base 102.

The linear motor actuator 100 may include any number of magnetic plates 104 having any dimensions. In one particular example, the linear motor actuator 100 may include between 50 and 60 magnetic plates 104, each with a length of 150 and 160 millimeters (mm). Accordingly, the length of actuation of the linear motor actuator 100 may be between 7.6 meters (m) and 9.6 m. While particular reference is made to example quantities and lengths of the magnetic plates 104 and length of actuation, the linear motor actuator 100 may include other quantities and lengths of magnetic plates 104 and length of actuation. The width of the magnetic plates 104, i.e., the dimension of the magnetic plates 104 in the width direction 116, which is perpendicular to the length direction 114, may vary based on application. As a specific example, the width of the magnetic plates 104 may be between 200 and 250 mm.

The linear motor actuator 100 also includes a movable platform 106. The movable platform 106 may take a variety of forms. In one example, the movable platform 106 may include coils 121, such as three-phase coils, as depicted in FIG. 1B. As described above, the electrical coils 121 may be an electric wire that carries current. Current passing through the electrical coils 121 generates a temporary electromagnetic field with a north and south pole. By changing the direction of electron flow through the electrical coils 121, a servo controller 112 can change the polarity of the electromagnetic field, which pulls or pushes the movable platform 106 along the guide rails 108-1 and 108-2.

In one particular example, the movable platform 106 may be an iron-core type platform that includes coils 121 wrapped around iron-core teeth 119 that extend below a top surface. Specifically, the movable platform 106 has a top surface, which may be formed of iron, with additional prongs (i.e., iron-core teeth 119) that extend down towards the base 102 and magnetic plates 104. The coils 121 are wrapped around these iron-core teeth 119. For simplicity, a single iron core tooth 119 and coil 121 are depicted with reference numbers. However, the movable platform 106 may include multiple instances of iron core teeth 119 and coils 121 across a length direction 114 and a width direction 116. In a specific example, an alternating three-phase current may be run through the coils 121 to generate a translating electromagnetic field. This electromagnetic field interacts with the magnetic field of the magnetic plates 104. This magnetic interaction generates a linear mechanical energy that translates the movable platform 106 over the magnetic plates in a length direction 114. While FIG. 1B depicts a particular type of movable platform 106 (i.e., with coils 121 wrapped around iron core teeth 119), the movable platform 106 may take other forms, such as a laminated or slotless form. In such a case, the coils 121 may be encased in resin and adhered to an iron top surface, rather than being wrapped around projecting teeth.

In either case, the electromagnetic field from the electrical coils 121 are either attracted to or repelled from the magnetic field of the magnetic plates 104. That is, a north pole of the electromagnetic field is repelled from a north pole of a nearby magnetic plate 104 and attracted to a south pole of a nearby magnetic plate 104. Accordingly, in principle, the linear motor actuator 100 generates movement by flipping the polarity of the electric coils 121 at different points in time to align the poles of the electromagnetic field and the magnetic fields to generate a movement in a length direction 114 of the linear motor actuator 100. In an example, the rate of change of the current controls the velocity of movement of the movable platform 106, and the value of the current determines the force generated, i.ee., the speed of the movable platform 106.

Accordingly, the linear motor actuator 100 is coupled to a servo controller 112, which provides the power to supply current to the electrical coils 121. That is, the servo controller 112 manages current provision to control the linear motor actuator 100 position and speed.

The linear motor actuator 100 may further include guide rails 108-1 and 108-2 that interact with bearings on the movable platform 106 to facilitate the relative motion of the movable platform 106 and the magnetic plates 104. That is, the movable platform 106 may include bearings within a housing. As the magnetic force translates the movable platform 106 in a particular direction, the bearings slide within grooves of the guide rails 108-1 and 108-2. A low friction, smooth, and precise movement of the movable platform 106 depends on the bearing/guide rail interaction. As either component wears down from use, the movement of the movable platform 106 becomes less smooth and potentially less precise. Accordingly, the guide rails 108-1 and 108-2 may be removable and replaceable. For example, the guide rails 108-1 and 108-2 may be affixed to the base 102 via any number of bolts 110 or other joining elements. For simplicity, a single bolt 110 in FIG. 1 is indicated with a reference number. However, as depicted in FIG. 1, the guide rails 108-1 and 108-2 are affixed to the base 102 via multiple bolts 110 in a length direction 114 of the base 102.

As described above, the linear motor actuator 100 may be used in various scenarios. For example, in one scenario, an electromagnet is positioned on top of the movable platform 106 and may selectively hold a piece of metal. The linear motor actuator 100 may be used to position the piece of metal into a workstation such as a laser welding workstation. When positioned as desired, the electromagnet releases the workpiece to be operated on (i.e., welded to another piece of material), and the movable platform 106 retracts from the workstation.

In another example, a multi-dimensional actuator is placed on the movable platform 106. For example, the multi-dimensional actuator may provide movement in an x-, y-, and z-direction and in a theta rotational direction. This multi-dimensional actuator may similarly include a magnet to selectively retain a piece of material. Accordingly, the linear motor actuator 100 may move the multi-dimensional actuator and retained piece of material into a workstation. When in the workstation, the multi-dimensional actuator may provide a higher resolution adjustment to the position of the workpiece to be laser welded, thus ensuring precise and accurate welding. Once in the workstation, the movable platform 106 with the mounted multi-directional actuator may be removed from the workstation to allow for workpiece welding. In either case, once a piece has been operated, similar linear motor actuators 100 may retrieve the workpiece from the workstation for transport to a downstream workstation (i.e., inspection and/or quality assurance). While particular reference is made to particular applications of a linear motor actuator 100, linear motor actuators 100 may also be used in other applications.

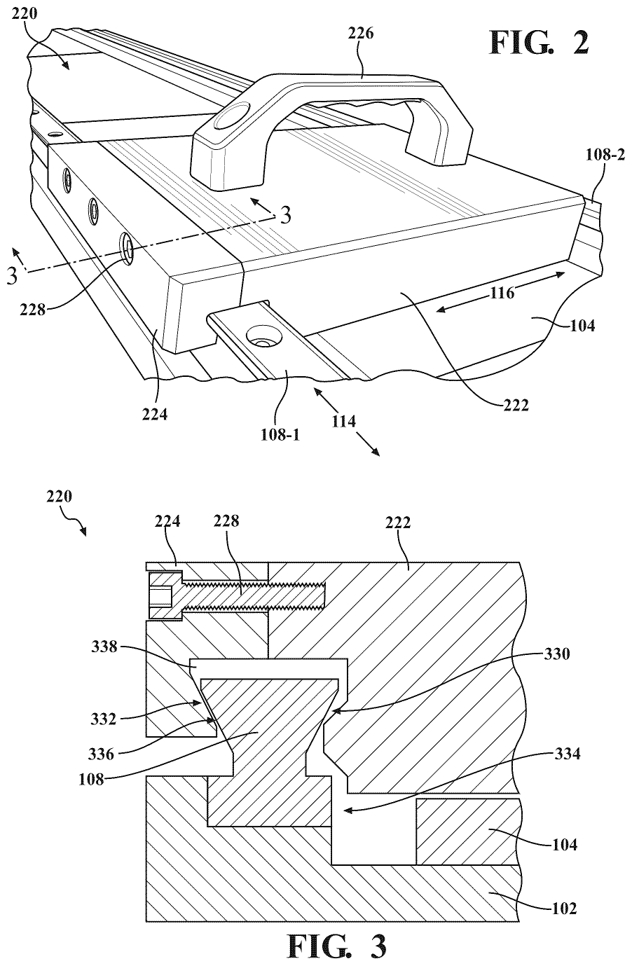

FIG. 2 is an isometric view of the rail removal device 220 on the guide rail 108 of the linear motor actuator 100. As described above, removing a worn-out guide rail 108 may be dangerous due to the attractive force between the magnetic plates 104 and the metal guide rails 108, with the attractive force being so great as to potentially injure an operator removing the worn guide rail 108. For example, the magnetic force may crush or pinch the operator's fingers between the magnetic plates 104 and the metal guide rails 108.

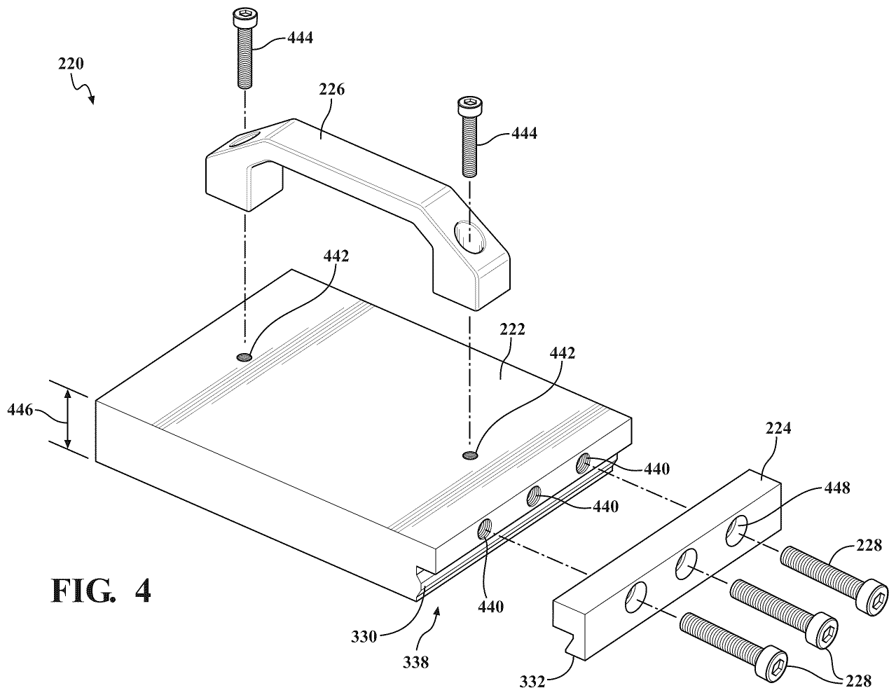

The rail removal device 220 includes a first plate 222 having a first mating surface (depicted in FIGS. 3 and 4) that aligns with a first lateral side of a guide rail 108 of the linear motor actuator 100. Similarly, the rail removal device 220 includes a second plate 224 having a second mating surface (depicted in FIGS. 3 and 4) that aligns with a second lateral side of the guide rail 108. When juxtaposed against one another, these mating surfaces form a channel that clamps around the guide rail 108. That is, the rail removal device 220 is a two-piece component with different halves (i.e., plates 222 and 224) joined together to clamp against the guide rail 108. In an example, the guide rail 108 has a particular cross-sectional profile, as depicted in FIG. 3, and the shaped ends of the first plate 222 and second plate 224 coincide with the cross-sectional profile of the guide rail 108. The interaction between the channel and the guide rail 108 facilitates the removal of the guide rail 108 from the linear motor actuator 100.

The linear motor actuator 100 further includes a joining structure that connects the first plate 222 to the second plate 224. To facilitate the installation of plates 222 and 224 around the guide rail 108, each plate 222 and 224 is positioned on a respective side of the guide rail 108. The joining structure may then be engaged to 1) draw the plates 222 and 224 towards one another and 2) draw the respective mating surfaces together to form the rail-matching channel. The joining structure may take a variety of forms. For example, as depicted in FIG. 2, the joining structure may include threaded bolt(s) 228 that pass through holes in the second plate 224 to engage with thread holes in the first plate 222. For simplicity, FIG. 2 depicts a single bolt 228 with a reference number. Additional details regarding this example of a joining structure are provided in connection with FIG. 4.

As depicted in FIG. 2, the first plate 222 may be sized to cover the width of the magnetic plate 104, which is positioned between a pair of guide rails 108-1 and 108-2 on the base 102 of the linear motor actuator 100. As described above, the width of the magnetic plate 104 may be a dimension of the magnetic plate 104 that is in a width direction 116 that is perpendicular to a direction of motion (i.e., a length direction 114) of the movable platform 106 of the linear motor actuator 100, which movable platform 106 is supported by the pair of guide rails 108-1 and 108-2. In one particular example, the first plate 222 may be between 200 and 250 mm. As described above, the first plate 222, while resting on the magnetic plate 104 when the channel is positioned over the guide rail 108, prevents the guide rail 108 from twisting, flipping, or moving towards and becoming magnetically stuck on the magnetic plates 104.

In an example, the length of the rail removal device 220 (i.e., in the length direction 114) may be between 100 and 200 mm. For example, the rail removal device 220 length may be 150 mm. This length provides enough mass for the rail removal device 220 bodies to remain in place to counter the magnetic attractive force between the guide rails 108 and the magnetic plates 104. While particular dimensions for the first plate 222 and the rail removal device 220 are described herein, the first plate 222, the second plate 224, and the rail removal device 220 may have a variety of different sizes and dimensions, which sizes and dimensions may be based on the dimensions of the guide rails 108 and/or the magnetic plates 104.

In an example, the first plate 222 and the second plate 224 are made of a non-ferrous material such as aluminum. Being formed of a non-ferrous material, the first plate 222 and the second plate 224 are not drawn to the magnetic plates 104. In another example, the first plate 222 and the second plate 224 may be formed of another non-ferrous material such as nylon. However, in some cases, the nylon plates, and in particular threads formed in the nylon, may have limited strength to 1) hold the plates 222 and 224 together and 2) hold the handle to the first plate 222. For example, in the event the guide rail 108 does magnetically adhere to the magnetic plate 104 while the rail removal device 220 is affixed to the guide rail 108, an operator may have to lift upward on the handle 226 with enough force to overcome the magnetic force between the magnetic plates 104 and the guide rail 108. The threads between the handle 226 and the first plate 222 bear this user-applied force to remove the guide rail 108. However, when exposed to this force to remove the guide rail 108 from the magnetic plates 108, the threads in a nylon-based plate may shear, and the handle 226 may break away from the first plate 222.

The rail removal device 220 also includes a handle 226 affixed to a plate. In particular, the handle 226 may be joined to the first plate 222. The handle 226 provides an operator with a lifting/grasping surface to remove/install the rail removal device 220 over the guide rail 108. The handle 226 may be formed of any material capable of withstanding the force applied to separate the guide rail 108 from the magnetic plate 104. In an example, the handle 226 is joined to the first plate 222 via threaded bolts or any other type of joining component.

FIG. 3 is a cross-sectional view of the rail removal device 220 on the guide rail 108 of the linear motor actuator 100. Specifically, FIG. 3 is a cross-sectional view taken along the line 3-3 in FIG. 2. As described above, the joining structure (e.g., a threaded bolt 228) brings the first plate 222 and the second plate 224 together to form a channel 338 that matches the cross-sectional profile of the guide rail 108. That is, the first mating surface 330 of the first plate 222 has a cross-sectional profile that matches or is similar to a first lateral side cross-sectional profile 334 of the guide rail 108 and a second mating surface 332 on the second plate 224 has a cross-sectional profile that matches or is similar to a second lateral side cross-sectional profile 336 of the guide rail 108. Accordingly, as depicted in FIG. 3, the channel 338 covers three sides of the guide rail 108.

The interaction between the surfaces of the first mating surface 330 and the second mating surface 332 with the first and second lateral sides of the guide rail 108 couple the motion of the guide rail 108 to that of the rail removal device 220. Accordingly, once the bolts 110 have been removed and the guide rail 108 is no longer affixed to the base 102, a user may lift up on the rail removal device 220 to remove the guide rail 108 for repair and/or replacement. Specifically, the first mating surface 330 includes a protrusion that interfaces with a first groove on the first lateral side of the guide rail 108, and the second mating surface 332 includes a protrusion that interfaces with a second groove on the second lateral side of the guide rail. Put another way, the channel 338 may have a dovetail cross-sectional profile to match the hourglass-shaped cross-sectional profile of the guide rail 108.

Put another way, the first lateral side and the second lateral side of the guide rail 108 may each include a groove through which the bearings of the movable platform 106 slide during the lateral translation of the movable platform 106. The protrusions of the first mating surface 330 and the second mating surface 332 may sit in these grooves to provide a clamp to couple the guide rail 108 to the rail removal device 220.

In an example, the first mating surface 330 cross-sectional profile may be different than the second mating surface 332 cross-sectional profile. This may be due to the different heights of the respective plates 222 and 224. For example, the outer edge of the base 102, where the second plate 224 rests, may be taller than the inner edge of the base 102, where the magnetic plates 104 and the first plate 222 rest. Accordingly, the mating surface profiles may be different to align with the asymmetric profile of the linear motor actuator 100.

FIG. 4 is an exploded view of the rail removal device 220. FIG. 4 clearly depicts the first plate 222 and the second plate 224. As described above, these plates 222 and 224 may have different dimensions, with the first plate 222 having a width (e.g., between 200 and 250 mm) to span the width of the magnetic plates 104 and the second plate 224 having a shorter width. The first plate 222 may also be thicker, in a thickness direction 446, than the second plate 224. For example, the first plate 222 may be between 30 and 40 mm, for example, 35 mm, while the second plate 224 may be between 25-30 mm, for example, 27 mm. This may allow the second plate 224 to rest on an elevated edge of the base 102 while the first plate 222 rests on the magnetic plates 104.

FIG. 4 also depicts the channel 338 and the first mating surface 330 and the second mating surface 332 that 1) define the cross-sectional profile of the channel 338 and 2) match the cross-sectional profile of the guide rail 108 to provide a grasping and lifting interface.

FIG. 4 also depicts the handle 226, joined to the first plate 222. Specifically, the handle 226 may be joined to the first plate 222 by threaded bolts 444. Specifically, the threaded bolts 444 pass through holes in the handle 226 to interface with threaded holes 442 in the first plate 222. The force to lift a magnetically attracted guide rail 108 from the magnetic plates 104 is carried by this threaded interface.

FIG. 4 also depicts a specific example of a joining structure between the first plate 222 and the second plate 224. Specifically, the joining structure may include threaded bolts 228 that pass through apertured 448 in the second plate 224 to engage with threaded holes 440 in the first plate 222 to bring the first plate 222 and the second plate 224 together to clamp against the guide rail 108. An example guide rail 108 removal process and guide rail 108 installation process will now be provided.

To remove a worn guide rail 108, an operator loosens and removes a subset of the bolts 110 that attach the guide rail 108 to the base 102. For example, the operator may loosen all but two of the bolts 110. The operator may adjust the threaded bolts 228 within the respective apertures 448 and threaded holes 440 to create a gap between the first mating surface 330 and the second mating surface 332 that may allow the rail removal device 220 to pass over and envelope the worn guide rail 108. The operator may then tighten the threaded bolts 228 to bring the first mating surface 330 and the second mating surface 332 into contact with the respective lateral sides of the worn guide rail 108. The operator may then remove the remaining bolts 110 that attach the worn guide rail 108 to the base 102. Using the handle 226, the operator may lift the worn guide rail 108 away from the base 102. In an example, the operator may pull the worn guide rail 108 away from the magnetic plates 104. Once the worn guide rail 108 is clear from the magnetic plates 104, the operator may set the worn guide rail 108 down and remove the threaded bolts 228 to release the worn guide rail 108 from the rail removal device 220.

To install a replacement guide rail 108, an operator adjusts the threaded bolts 228 within the respective apertures 448 and threaded holes 440 to create a gap between the first mating surface 330 and the second mating surface 332 that may allow the rail removal device 220 to pass over and replacement guide rail 108. The operator may then tighten the threaded bolts 228 to bring the first mating surface 330 and the second mating surface 332 into contact with the respective lateral sides of the replacement guide rail 108. Using the handle 226, the operator may set the replacement guide rail 108 in place on the base 102, being cautious to maintain the replacement guide rail 108 away from the magnetic plates 104. With the rail removal device 220 still attached to the replacement guide rail 108, the operator may attach the replacement guide rail 108 to the base 102 by tightening a subset (e.g., two) of the bolts 110 that attach the replacement guide rail 108 to the base 102. Once a subset of the bolts 110 are tightened, the operator may remove the threaded bolts 228 to release the replacement guide rail 108 from the rail removal device 220. The operator may then tighten the remaining bolts 110 that attach the replacement guide rail 108 to the base 102.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-4, but the embodiments are not limited to the illustrated structure or application.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A rail removal device, comprising:
a first plate having a first mating surface that aligns with a first lateral side of a guide rail of a linear motor actuator;
a second plate having a second mating surface that aligns with a second lateral side of the guide rail;
a joining structure connecting the first plate and the second plate that, when closed, juxtaposes the mating surfaces to define a channel that clamps against the guide rail; and
a handle affixed to a plate.

2. The rail removal device of claim 1, wherein:
the first mating surface has a cross-sectional profile that aligns to a first lateral side cross-sectional profile of the guide rail;
the second mating surface has a cross-sectional profile that aligns to a second lateral side cross-sectional profile of the guide rail; and
the channel covers three sides of the guide rail.

3. The rail removal device of claim 1, wherein a first mating surface cross-sectional profile is different than a second mating surface cross-sectional profile.

4. The rail removal device of claim 1, wherein:
the first plate is sized to cover a width of a magnetic plate positioned between a pair of guide rails on a base of the linear motor actuator;
the width of the magnetic plate is in a direction that is perpendicular to a direction of motion of a movable platform of the linear motor actuator; and
the movable platform is supported by the pair of guide rails.

5. The rail removal device of claim 4, wherein the first plate rests on the magnetic plate when the channel is positioned over the guide rail.

6. The rail removal device of claim 1, wherein the handle is affixed to the first plate which spans a width of a magnetic plate positioned between a pair of guide rails on a base of the linear motor actuator.

7. The rail removal device of claim 1, wherein:
the first mating surface comprises a protrusion that interfaces with a first groove on the first lateral side of the guide rail; and
the second mating surface comprises a protrusion that interfaces with a second groove on the second lateral side of the guide rail.

8. The rail removal device of claim 1, wherein the joining structure comprises a threaded bolt that passes through an aperture in the second plate to engage with threaded holes in the first plate to bring the first plate and the second plate together to clamp against the guide rail.

9. The rail removal device of claim 1, wherein the first plate and the second plate are formed of a non-ferrous material.

10. The rail removal device of claim 1 wherein the first plate is thicker than the second plate.
